(19) United States
(12) Patent Application Publication
(10) Pub. No.: US 2008/0106177 A1
(43) Pub. Date: May 8, 2008

(54) Fluorescent lamp utilizing a partial barrier coating resulting in assymetric or oriented light output and process for same

(76) Inventors: Jon B. Jansma, Pepper Pike, OH (US); Ernest W. Balch, Ballston Spa, NY (US); Donald F. Foust, Glenville, NY (US); Jason M. Benyeda, Glens Falls, NY (US)

Correspondence Address: FAY SHARPE LLP, 1100 SUPERIOR AVENUE, SEVENTH FLOOR, CLEVELAND, OH, 44114, US

(21) Appl. No.: 11/593,726

(22) Filed: Nov. 7, 2006

(51) Int. Cl. H01J 5/00; B05D 5/12

(52) U.S. Cl. 313/317; 427/106

(57) ABSTRACT

A lamp comprising a light-transmissive envelope, the inner surface of which is only partially coated by a reflective barrier coating layer such that an aperture is created in the coating for light emission, the lamp exhibiting asymmetric light output through the aperture and lumens substantially equivalent to a lamp wherein the envelope inner surface is completely coated with a reflective barrier coating layer having no aperture, and a laser ablation process for creating the reflective barrier coating layer aperture.

### BACKGROUND OF THE INVENTION

The present disclosure relates to a fluorescent lamp having a partial barrier coating applied to the inner surface of the lamp which results in the emission of light in an asymmetric or oriented manner, and to a process to produce the lamp. It finds particular application in specialty fixtures that utilize a linear array of closely packed lamps used to maximize light levels for a given area. In addition, it finds application in conventional fixtures where dust and surface contamination build-up over the life of the lamp causing light depreciation. However, it is to be understood that the present disclosure is also amenable to other like applications.

One of the specialty applications referred to above exists where a linear array of closely packed lamps is used to maximize light levels for a given fixture area and size. Lamps employed for this purpose may be compact in nature, though other conventional lamps may also be used. In that instance where the lamps used are closely spaced, i.e., close enough to one another that the external fixture reflectors of the lamps are ineffective, considerable loss of fixture light output can occur from the lamp sides and backs. Examples of lamps used in this manner would be flat panel display backlighting, or stage lighting fixtures where space is limited and light levels must be high and uniform.

For conventional lamp applications, even when lamps are spaced for optimal fixture performance, light loss during lamp life due the buildup of dust and dirt on the lamp exterior and fixture can be significant. The cost of lamp and fixture cleaning can be prohibitive, and at the least represents a significant operating cost factor. According to the IES Lighting Handbook, Application Volume, 1981, ISBN 0-87995-008-0, the light level loss due to light absorbing dirt build-up can be as much as 20% within several years time, depending upon the application environment. Some industrial conditions cause light depreciation, due to dirt build-up, much more rapidly. In today's lighting market, where lamp makers claim better than 90% lumen maintenance for clean lamps, an improvement of 10-20% in effective light level maintenance, due to resistance to the effect of dirt and dust, would be of great significance to many lighting systems users. Use of a lamp with asymmetric light output, oriented downward and away from the fixture, will reduce the effect of dust and dirt build up on the lamp and fixture upper surface, resulting in significantly improved light maintenance for customers. The lamp design described herein provides efficient asymmetric oriented light output and improved light level maintenance.

The use of apertures in lamp coatings to achieve certain light emission characteristics is known. Tailoring of emission parameters has historically been accomplished by removal of a portion of not only the reflective coating layer but also the adjacent phosphor coating layers including the phosphor layer. Removal of these coating layers reduces lamp lumens and consequently lamp life and utility. While it would be beneficial to remove only a partial or single layer, this has proved difficult using known coating removal techniques, such as mechanical scraping or brushing, or resist or etching methods. These methods do not afford accurate, precise or repeatable coating layer removal and are not generally coating layer selective. Also, it is difficult to control aperture size, shape and edge gradation. These techniques are conducted inside the lamp envelope which is costly and inefficient. Alternatively, apertures have been created by partial coating layer deposition techniques, but these techniques also suffer from problems related to coating edge position control and repeatability under production conditions. All of these generally known methods result in lamps exhibiting lumen loss as compared to coated lamps not having coating apertures.

The invention disclosed herein is intended to provide a lamp which exhibits good asymmetric performance and provides a significant benefit when used in compact fixtures where lamps are closely spaced. In addition, the invention provides a method for producing a lamp with these features. An oriented asymmetric light output lamp, when used under conditions of close lamp spacing, for example less than 1 lamp diameter apart, is significantly more efficient in terms of incident light levels measured in front of the fixture, in the direction in which light illumination is desired. This conclusion is especially true when the measured overall lamp lumens are approximately equal for known symmetric lamps and asymmetric lamps according to the invention.

### BRIEF DESCRIPTION OF THE INVENTION

A fluorescent lamp and a method for making the same is provided. The lamp includes a partial reflective barrier coating that maximizes light output in an oriented manner with little or no attendant lumen loss. The lamp exhibits improved light directivity from an aperture in the reflective barrier coatings of the oriented surface of the lamp, generally along the long axis of the lamp. The aperture in the reflective barrier coating is created by an exterior laser ablation method prior to application of the phosphor coating layer.

### BRIEF DESCRIPTION OF THE DRAWINGS

FIG. 1 shows diagrammatically, and partially in section, a fluorescent lamp according to the present invention.

FIG. 1A shows the lamp of FIG. 1 with additional coating.

FIG. 2 is a graph plotting illuminance (LUX) as a function of lamp orientation for lamps made with varying aperture size.

FIG. 3 is a graph plotting barrier aperture size as a function of the peak in asymmetric light output.

FIG. 4 is a photograph of a lamp envelope according to the invention.

### DETAILED DESCRIPTION OF THE INVENTION

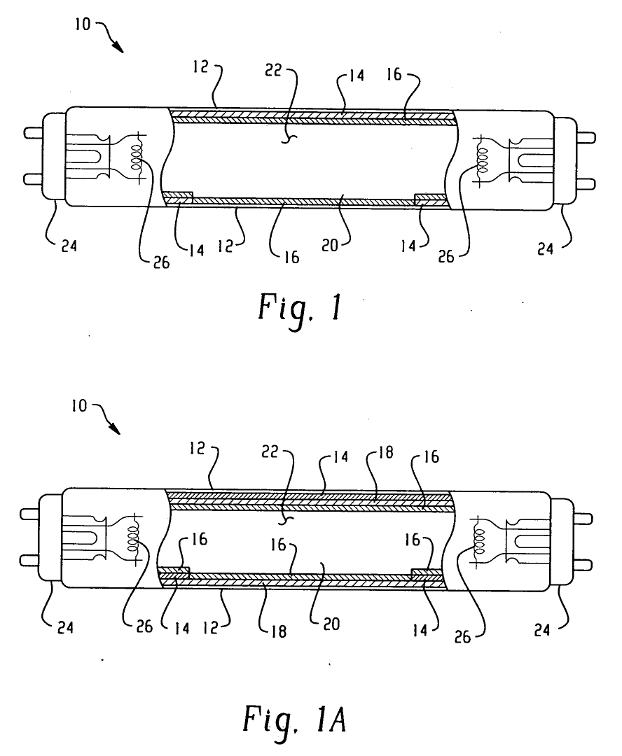

With reference to FIG. 1, there is shown a representative fluorescent lamp 10, which is generally known in the art. The fluorescent lamp 10 has a glass tube or light-transmissive envelope 12 which has a circular cross-section, and would include the conventional electrodes 26, fill gas 22, and mercury components known in the art. The tube 12 is hermetically sealed at both ends by bases 24. The electrodes 26 are mounted in the bases 24, and provide an arc discharge. The inner surface of the glass tube is provided with two coating layers, the first of which is a reflective barrier coating layer 14, which is deposited adjacent the inner surface of the envelope 12. This reflective barrier coating layer may be of the type disclosed in U.S. Pat. No. 5,602,444, to our common assignee. The coating may be deposited such that the entire circumference of the lamp envelope 12 is not coated with reflective barrier coating material layer 14, thus creating aperture 20 which functions to direct lamp output. Alternatively, the reflective barrier coating material layer 14 may be deposited in the conventional manner, and then removed from that portion of lamp envelope 12 where it is desirable to have an aperture 20. In that instance where the coating is deposited such that the entire inner surface of envelope 12 is coated, the aperture can be formed in a number of ways, for example by mechanical scraping, resist coating, laser ablation, or coating a tilted bulb. The aperture 20 may remain uncoated with regard to barrier coating material layer 14, or may be coated with a transparent barrier coating layer 18, included in FIG. 1A, deposited to protect the glass envelope. Even if this transparent coating is used, the aperture remains void of reflective barrier coating material such that visible light is not reflected by this portion of the lamp envelope. Put differently, a visible light aperture is introduced into the reflective barrier layer coating.

The aperture in the reflective barrier layer coating may range in size from 10 to 240 degrees, preferably from 60 to 180 degrees, and more preferably from 110 to 130 degrees.

As was noted earlier, the aperture in the reflective barrier layer may be formed by any of a number of methods, including but not limited to partial layer deposition, resist coating, mechanical brushing, scraping, or laser ablation. Factors to be considered in determining what method may best achieve the desired outcome include automation restrictions, uniformity, and accuracy with respect to edge gradations. Of particular interest for forming aperture 20 in lamp envelope 12 is the use of a technique that removes the barrier coating layer to produce aperture 20 using laser light. The process used is precise, consistent and cost effective. The process is employed after one or more layers have been deposited on the inner lamp envelope surface. The process involves the use of controlled light intensity and wavelength, resulting in the rapid heating of the coating to be ablated which produces a gas that causes the coating to dislodge from the bulb wall. The laser wavelength is selected to minimize absorption by the glass bulb. In addition, the laser incidence on the bulb must be minimized to avoid degradation of the bulb. This is accomplished by controlled movement in the area of light impact on the bulb, which may involve moving the bulb relative to the laser, or the laser relative to the bulb, or a combination thereof, which results in the capability to remove coating layer(s) in any desired pattern.

The laser ablation may be conducting using, for example, an ESI 5200 laser, or other similar source. The power necessary to ablate the reflective barrier coating layer, while it is specific to the layer content and physical parameters, is between about 0.5 milijoules/cm² to about 500 milijoules/cm². The laser bite size, depending on the laser employed, may be up to about 30 μm, preferably 20 μm. The laser beam velocity is highly dependent on the size and wavelength of the laser, but may be up to about 60 mm/sec or more. The foregoing parameters are exemplary only, due to the fact that they are highly dependent on the laser technology employed, as well as the coating and lamp characteristics.

Aperture 20 may be oriented with respect to the base pins of the lamp. This orientation allows the user to easily direct the brightest lamp output in the desired direction upon installation of the lamp in the fixture. In addition, the lamp exterior may be marked by any conventional technique to assist the consumer in proper installation of the lamp to fully benefit from the inventive coating design.

Now, with reference to FIGS. 1 and 1A, the inner surface of the envelope 12 bears a second coating layer which is a phosphor layer 16. The phosphor layer may be comprised of any of the known phosphors or phosphor blends conventionally used in the manufacture of fluorescent lamps. This layer is deposited over the reflective barrier coating layer 14, and will cover the entire inner envelope, including aperture areas, whether these areas are or are not coated with a transparent, non-reflective coating layer 18. The phosphor layer 16 can be deposited by conventional deposition techniques, and should be deposited such that the reflective barrier coating layer 14 is not adversely affected by the deposition thereof. Of course, additional coatings may be used as desired.

The lamp including the foregoing features exhibits oriented asymmetric light output, or directed light output, with approximate equivalent overall lumens as compared to standard symmetric-type lamps. This lamp will now be described with regard to the following examples.

### EXAMPLE 1

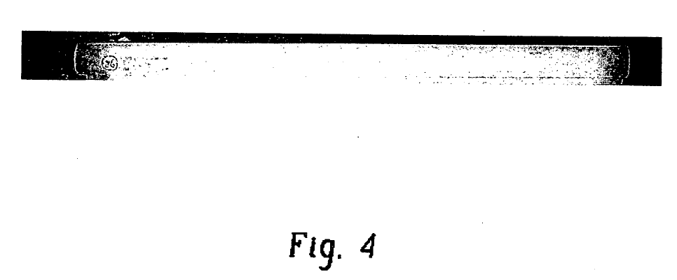

The subject inventive coating technique was applied to the manufacture of T8 lamps. The lamps were prepared using a first reflective coating material layer, the material being in keeping with that disclosed in U.S. Pat. No. 5,602,444 to our common assignee, in conjunction with a second conventional phosphor material layer. The reflective barrier coating was deposited by conventional lamp coating techniques. The lamp envelope was then externally exposed to a laser light source. The reflective barrier layer coating was ablated to generate apertures in the coating layers. Ablation was conducted using an ESI 5200 laser. It was operated at a power of 2 watts and bite size of 10 μm. The beam velocity was 50 mm/sec, using multiple passes at 20 μm line to line spacing. Subsequent to the laser ablation process the phosphor material layer was deposited over the entire inner surface of the lamp envelope. FIG. 4 is a photograph of a lamp having an aperture produced by the subject technique, which is accomplished without the need to enter the lamp envelope interior. While the aperture shown in FIG. 4 does not extend the full length of the lamp envelope, the size and shape of the aperture can be easily modified to meet the use requirements for the fixture or lamp.

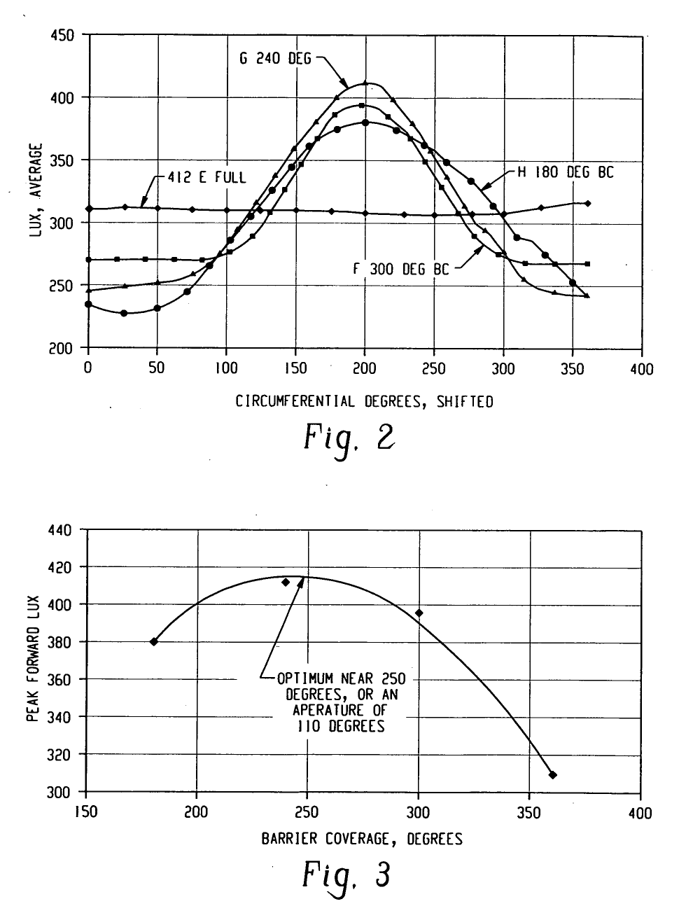

Lamps made various barrier coat aperture size were subjected to light symmetry testing in accord with IES document LM-41. The result of this testing or measurement is shown in FIG. 2, which shows the extent of asymmetry possible. Specifically, the plot shows the extent of asymmetry as the lamp is rotated, shown in terms of lux as a function of circumferential degrees. The height of the peak in measured incident light level (lux) is an indication of optimal aperture size for directed light output. This is better understood with reference to FIG. 3, which provides a plot of barrier aperture size as a function of the peak in asymmetric light output, or optimum aperture size. Lamps having coating apertures as described herein may be used in many applications, including, but not limited to, cinema, stage, or theater lighting, industrial lighting, reprographic lighting, sign-edge lighting, and flat panel display backlighting, among others.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A lamp comprising a light-transmissive envelope, the inner surface of which is only partially coated by a reflective barrier coating layer such that an aperture is created in the coating for light emission, the lamp exhibiting asymmetric light output through the aperture and lumens substantially equivalent to a lamp wherein the envelope inner surface is completely coated with a reflective barrier coating layer having no aperture.

2. The lamp of claim 1 wherein the aperture extends along the long axis of the lamp.

3. The lamp of claim 1 wherein a base of the lamp is marked to identify orientation of asymmetric light output.

4. A process for ablating one or more coating layers from the inner surface of a coated lamp envelope comprising irradiating a portion of the exterior surface of the lamp envelope with laser light such that at least one coating layer is heated and dislodged from the envelope inner surface to create an aperture in the coating layers for directing lamp emission.

5. The process of claim 4 wherein the aperture is created in the reflective barrier coating layer prior to deposition of the phosphor layer.

6. The process of claim 4 wherein the aperture extends along the long axis of the lamp.

7. The process of claim 4 wherein the laser light is operated at a power of at least 0.5 milijoules/cm² and the bite size of at least 30 μm, and a beam velocity of at least 40 mm/sec.

8. The process of claim 4 wherein the laser source is moved relative to the lamp envelope during the ablation process.

9. The process of claim 4 wherein the lamp envelope is moved relative to the laser beam during the ablation process.
